(19) United States
(12) Patent Application Publication
(10) Pub. No.: US 2024/0287325 A1
(43) Pub. Date: Aug. 29, 2024

(54) IMPROVED RESIN SYSTEM FOR FOAMING FIRE-RESISTANT COATINGS

(71) Applicant: Röhm GmbH, Darmstadt (DE)

(72) Inventor: Bruno Keller, Wackernheim (DE)

(73) Assignee: Röhm GmbH, Darmstadt (DE)

(21) Appl. No.: 18/294,449

(22) PCT Filed: Jun. 27, 2022
(86) PCT No.: PCT/EP2022/067499

§ 371 Date: Feb. 1, 2024

(30) Foreign Application Priority Data
Aug. 2, 2021 (EP) 21189015.7

(51) Int. Cl. C09D 5/18; C08F 2/01; C08F 265/06

(52) U.S. Cl. CPC C09D 5/185; C08F 2/01; C08F 265/06

(57) ABSTRACT

A reactive resin system for intumescent coating can be made. Intumescent coatings are used for fire protection of metallic building components. In the event of a fire, said coatings undergo reactive foaming that results in the formation on the metal girder of a fireproof insulating layer having low thermal conductivity and that retards any early, thermally induced failure of said building component. A methacrylate-based resin system is produced by a process in which a first monomer fraction is polymerized to a maximum degree of 95% by weight and diluted with a second monomer mixture. The glass transition temperature of the polymeric component of the composition that is formed is low compared with the art. Organic acids incorporated into the resin system have synergistic effect with the filler system. The resin systems produced are found to be efficient at thermally induced foaming, because of their fine-pored and closed-pored foam structure.

### FIELD OF THE INVENTION

The present invention relates to a novel reactive resin system for intumescent coating and to a process for producing said resin system. Intumescent coatings are used in particular for fire protection of metallic building components, such as steel girders in building construction. In the event of a fire, said coatings undergo reactive foaming that results in the formation on the metal girder of a fireproof insulating layer having low thermal conductivity and that—through the insulation that this creates—retards any early, thermally induced failure of said building component.

The present invention relates in particular to methacrylate-based resin systems produced by means of a novel process in which a first monomer mixture is polymerized to a maximum degree of 95% by weight and then diluted with a second monomer mixture. The glass transition temperature of the polymeric component of the composition that is formed is particularly low by comparison with the prior art. In addition, the organic acids incorporated into the resin system have a surprising synergistic effect with the filler system. The resin systems thus produced are found to be particularly efficient at thermally induced foaming, by virtue of their fine-pored and closed-pored foam structure.

### PRIOR ART

A first generation of intumescent coating systems was based on high-molecular-weight thermoplastic resins based on acrylates, methacrylates and/or vinyl monomers and require a large amount of solvent or water for application to the appropriate metal surface, with correspondingly long drying times.

It is customary for such intumescent coatings to be applied on site during the construction phase. Off-site application prior to delivery to the construction site is however preferable, since this can take place under controlled conditions. However, a coating that is slow to dry means an inefficient processing time, especially since it must be applied successively from different sides in order to be complete.

CN 112 029 367 A describes, for example, an intumescent system in the form of an emulsion that comprises core-shell particles in water. The core of the core-shell particles is crosslinked.

CN 111 995 919 A discloses, as does CA 3 028 431, emulsions of acrylic polymers in the form of ultrathin intumescent coatings. The acrylic polymers are present in the form of core-shell particles, the core being crosslinked.

JP 2003 171 579 relates to a mixture of an unpolymerized (meth)acrylic monomer mixture and a (meth)acrylic polymer. The mixture can be used as an intumescent coating. Termination of the polymerization at a defined degree of polymerization is not disclosed.

DE 196 30 063 relates to interior fitout parts for rail vehicle components. Intumescent coatings are not disclosed.

Epoxy-based intumescent coatings are preferably used in the off-shore industry. They have the characteristic feature of good ageing resistance and relatively short drying times Polyurethane systems have been intensively investigated. They likewise have the characteristic feature of a relatively short drying time and good water resistance. However, the results of fire tests were unsatisfactory, since the coating has poor adhesion to steel. Details thereof can be found in Development of alternative technologies for off-site applied intumescent, Longdon, P. J., European Commission, [Report] EUR (2005), EUR 21216, 1-141.

A further generation of intumescent coatings is based on (meth)acrylate reactive resins. The application thereof has the great advantage that no solvent is required here; once applied, the resin does however cure relatively rapidly by comparison with the systems described above. This gives rise not only to more swift processing, but also in particular to a lower content of residual volatile constituents in the applied coating. Such intumescent coating systems were disclosed for the first time in EP 1 636 318.

A further improvement in the (meth)acrylate-based systems was subsequently described for example in EP 2 171 004. This has the characteristic feature of a particularly high content of acid groups to improve metal adhesion. EP 2 171 005 discloses a further development of a system of this kind. This has the particular characteristic feature of copolymerization of diacids or copolymerizable acids having a spacer group. This can additionally improve metal adhesion.

All of these systems are however in need of further improvement. For example, there is very little freedom as regards formulation options. Also, only relatively thick layers can be applied. The combined effect of these disadvantages means also, for example, that the foam height in the event of need or fire can be preset only to a minimal extent.

In addition, disadvantages also arise from the relatively complex production process of the resins. What all otherwise very advantageous (meth)acrylate systems described in the prior art have in common is that the solid thermoplastic polymer present in the resin is here produced only separately, then dissolved in the monomer components and preformulated with additives before finally undergoing final formulation shortly before application as a 2C system. This process chain is relatively complicated and there is great interest in making it simpler WO 2021/180488 describes for the first time the production of a methacrylate-based reactive resin for intumescent coatings in a syrup process. In this process, a monomer mixture is polymerized up to a degree of polymerization of 70%, after which the polymerization is terminated. The composition is here essentially similar to the reactive resins already known that are obtained by dissolving a polymer suspension or granulate in a monomer mixture. Differences arise primarily through the nature of the polymer chains.

### Object

The object of the present invention was accordingly to provide a significantly simplified process for producing (meth)acrylate-based intumescent coatings.

In particular, there was the need for a simplified manufacturing process in which at least one insulation step or formulation step can be dispensed with compared to the processes for producing (meth)acrylate-based intumescent coatings described in the prior art.

The further object was to provide a novel formulation for 2C intumescent coating that, in addition to very good metal adhesion and easy processability, additionally permits greater freedoms as regards additivation and the adjustment of subsequent foaming control, particularly as regards the presetting of subsequent foam heights and foam quality, for example a particularly high fraction of closed-pore foam.

Further objects that are not mentioned explicitly may become apparent hereinbelow from the description or the examples, and from the overall context of the invention.

### Solution

The objects are achieved by the provision of a novel process for producing reactive resins for intumescent coatings. In this process, a first monomer mixture comprising at least one acid-functionalized monomer is firstly polymerized to a degree of polymerization of 70% by weight to 95% by weight. On reaching the desired degree of polymerization, the polymerization is then terminated. The polymer thereby formed has in accordance with the invention a glass transition temperature, calculated according to the Fox equation, of less than 23° C., which is significantly lower than that reported for corresponding resins in the prior art. The process of the invention is in addition characterized in that, after termination of the polymerization, the mixture containing 70% to 95% by weight of polymer is diluted with a second monomer mixture that differs from the first monomer mixture.

Foaming fire-resistant coatings described in the prior art consist inter alia of multicomponent systems that are essentially formulated from thermoplastic polymers dissolved in monomers. The present invention shows on the other hand that liquid polymers, i.e. polymers having a glass transition temperature below 23° C. that would be liquid in the undissolved state at room temperature, are likewise suitable for use. In addition, polymerized acid components, such as inter alia 2-carboxyethyl acrylate, are used improve adhesion to the substrate and acid components additionally added to the formulation, such as inter alia acrylic acid or methacrylic acid, are used for surprising foam height control in the final use as a fire-resistant paint.

The Fox equation is a method that is very simple, but provides results close to reality, for calculating glass transition temperatures of homogeneous copolymers (i e. copolymers having randomly distributed repeat units), which has proven particularly useful for (meth)acrylate copolymers (optionally with styrene). The (meth)acrylate notation here includes co-acrylates, co-methacrylates and also copolymers comprising acrylates and methacrylates. For two monomers, the Fox equation is as shown below, it being also possible to extend this accordingly to a multitude of different comonomers:

$${T}_{g} = {T}_{g 1} ( {x}_{1} ) + {T}_{g 2} ( {x}_{2} ) … + {T}_{gy} ( {x}_{y} )$$

where
T_{g}: Theoretically determined glass transition temperature of the copolymer
T_{gy}: Glass transition temperature of a homopolymer of monomer y
x_{y} Proportion by mass of monomer y in the monomer mixture or in the repeat units of the polymer

In accordance with the invention, the cited values for all glass transition temperatures relate to polymers produced by free-radical processes at polymerization temperatures of between 40 and 120° C. that are customary therefor. Exotic polymers produced at significantly lower temperatures, for example by an anionic polymerization, or that were produced stereoselectively by a GTP, play no part in the invention. For such polymers, the very different tacticities mean that the Fox equation is also not applicable in the chosen form. The glass transition temperatures of the homopolymers produced by free-radical polymerization are known from the literature.

In the context of the present invention, a monomer mixture is understood as meaning customarily a monomer mixture that is free of solvent. More particularly, a monomer mixture for the purposes of the present invention does not contain any water. A monomer mixture is therefore preferably a mixture that consists of monomers. These explanations and preferences apply independently both to the first monomer mixture and to the second monomer mixture.

The first monomer mixture preferably consists to an extent of at least 90% by weight of acrylates and/or methacrylates, based on the total weight of the first monomer mixture. Equally preferably, the acid-functionalized monomer in the first monomer mixture is acrylic acid, methacrylic acid, itaconic acid and/or 2-carboxyethyl acrylate, preferably methacrylic acid and/or 2-carboxyethyl acrylate. In addition, the first monomer mixture preferably comprises, besides the acid-functionalized monomer, as further monomers, methyl (meth)acrylate (MMA), n-butyl (meth)acrylate, isobutyl (meth)acrylate, ethyl (meth)acrylate, propyl (meth)acrylate, ethylhexyl (meth)acrylate and/or styrene. The first monomer mixture particularly preferably consists to an extent of at least 95% by weight, based on the total weight of the first monomer mixture, very particularly preferably exclusively, of the monomers recited herein.

The monomer mixture here very particularly preferably contains 20% to 45% by weight, more preferably 25% to 40% by weight, of a methacrylate, such as ethylhexyl methacrylate in particular. Preferably, up to 10% by weight of the acid-functionalized monomer(s) is employed in the monomer mixture, in each case based on the total weight of the first monomer mixture.

In one embodiment of the invention, the first monomer mixture does not contain any styrene. The first monomer mixture is thus preferably styrene-free.

It is further preferable that the first monomer mixture in the form of acrylate and/or methacrylate does not contain a crosslinker. Particularly preferably, the first monomer mixture does not contain a crosslinker.

A “crosslinker” is in the context of the present invention understood as meaning a monomer which contains two or more functional groups that can polymerize in the polymerization of the invention, especially in a free-radical polymerization.

The degree of polymerization on termination of the polymerization is preferably between 85% and 95% by weight. Particularly preferably, the polymer formed according to the invention from the first monomer mixture contains between 1% and 10% by weight, preferably between 2.5% and 5% by weight, of repeat units of the acid-functionalized monomer, based on the total weight of the polymer formed. Further preferably, the polymer formed has a weight-average molecular weight M_{w} of between 10 000 and 200 000 g/mol, preferably between 20 000 and 150 000 g/mol and more preferably between 30 000 and 100 000 g/mol and has a glass transition temperature of between −° C. and 20° C., preferably between −5 and 15° C.

These cited glass transition temperature values likewise relate to a value preset by means of the Fox equation. The glass transition temperature actually obtained at the end can after the polymerization be determined for example by DSC (differential scanning calorimetry, for example in accordance with ISO 11357-1 and in particular −2). When using the abovementioned monomers, the value determined by this method generally differs only minimally from the value preset by means of the Fox equation. If monomers other than these are used, this can in very rare cases result in block-form distribution of the repeat units in the chain. In very rare cases, the block formation can be so pronounced that the polymer has two or more glass transition temperatures. For these very rare, not preferable cases according to the invention, it is no longer the calculation of the glass transition temperature by means of the Fox equation that is decisive, but the determination of the most pronounced glass transition temperature in accordance with standard ISO 11357-2 defined above.

The weight-average molecular weight is here determined by GPC against a PMMA standard using at least two suitable columns with THF as eluent.

It has surprisingly been found to be particularly advantageous when the polymer formed in the process of the invention has a glass transition temperature below the ambient room temperature, i.e. when it would be liquid at room temperature even in the isolated state.

The polymerization can in particular be carried out discontinuously in a batchwise process or continuously in the continuously operated stirred-tank reactor with connecting flow tube. The termination of the reaction can here be essentially ended independently of the mode of operation, but in each case tailored thereto by lowering the temperature, adding an inhibitor and/or simply through consumption of the initiator.

Preferably, the second monomer mixture contains 50% to 90% by weight, more preferably 75% to 85% by weight, of methyl (meth)acrylate (MMA), based on the total weight of the second monomer mixture. Further preferably, the second monomer mixture contains to an extent of at least 90% by weight of acrylates and/or methacrylates and optionally styrene, preferably of MMA, n-butyl (meth)acrylate, isobutyl (meth)acrylate, ethyl (meth)acrylate, propyl (meth)acrylate and/or ethylhexyl (meth)acrylate, up to 5% by weight of acid-functionalized monomers, preferably acrylic acid, methacrylic acid, itaconic acid and/or 2-carboxyethyl acrylate, and optionally to an extent of not more than 5% by weight of styrene, in each case based on the total weight of the second monomer mixture. In an alternative preferred embodiment of the present invention, the second monomer mixture contains 55% to 80% by weight, more preferably 60% to 75% by weight, of methacrylate, in each case based on the total weight of the second monomer mixture, wherein methyl (meth)acrylate and n-butyl (meth)acrylate are here used for example in a ratio of from approx. 80% by weight to 20% by weight to 50% by weight to 50% by weight.

In one embodiment, the second monomer mixture has a content of acid-functional monomers within a range from 0.5% to 2% by weight based on the total weight of the second monomer mixture.

“Acid-functional monomers” is in the context of the present invention understood as meaning both just one acid-functional monomer and also a mixture of two or more acid-functional monomers.

Further preferably, the second monomer mixture does not contain any styrene. The second monomer mixture is therefore preferably styrene-free. Particularly preferably, the reactive resin is styrene-free.

It is further preferable that the second monomer mixture does not contain a crosslinker. Particularly preferably, the reactive resin does not contain a crosslinker. For the term “crosslinker”, the explanations and preferences described previously apply.

Particularly preferably, the second monomer mixture is selected such that, when fully polymerized, it would lead to a polymer having a glass transition temperature according to the Fox equation of between 50° C. and 120° C., preferably between 60 and 90° C. It should at this point be made clear that the polymer in the finished intumescent coating formed from predominantly these monomers of the second monomer mixture must in the majority of cases deviate from the theoretical glass transition temperature of the second monomer mixture calculated by means of the Fox equation, since this second polymerization takes place during curing on the basis of a mixture of the second monomer mixture and up to 30% by weight of the remaining first monomer mixture, which differs from the second one, based on the total weight of the reactive resin.

Besides the process of the invention, the present invention also provides a novel formulation for the 2C intumescent coating. This formulation is in particular characterized in that, at a point in time after mixing the 2C system, it contains 20% to 40% by weight of the reactive resin produced by the process of the invention, 35% to 60% by weight of a blowing agent, 0.1% to 2.5% by weight of a peroxide and/or azo initiator, preferably only peroxides, such as for example benzoyl peroxide, optionally up to 2% by weight of an accelerator, optionally 4.9% to 15% by weight of additives and 5% to 30% by weight of fillers. Optionally, the formulation can include additional pigments, in each case based on the total weight of the 2C system.

The additives may in particular be wetting agents, film-forming agents, deaeration reagents and/or dispersing agents. The accelerators optionally used are generally secondary amines.

The fillers may for example be silica, titanium dioxide, quartz or other, in particular thermally stable, inorganic compounds. Inorganic fillers such as carbonates that can undergo thermal decomposition may be used only to a more minor extent, in order to avoid uncontrolled additional foaming of the coating in the event of fire. A particularly preferred filler is titanium dioxide.

For the blowing agents, there are various alternatives. In a particularly preferred alternative, polyphosphates may be used, which at 190 to 300° C. are converted into phosphoric acid. The formulation additionally includes pentaerythritol, which above 300° C. in the presence of the phosphoric acid then forms a carbon foam with the elimination of water and carbon dioxide. In this process, water and carbon dioxide act as blowing agents. An additional advantage of this alternative is that both the polyphosphates and the phosphoric acid act as additional flame retardants.

In a second alternative, melamine is used as base material for the blowing agent, which above 350° C. decomposes to ammonia, nitrogen and carbon dioxide, with all three of these in turn acting as blowing agents.

A combination of these two alternatives as a third, particularly preferred variant makes it possible to additionally achieve further benefits besides the flame retardant action. In this way, it is possible to tune the degree of foaming more finely. Moreover, foaming takes place gradually, which is in turn advantageous in respect of foam stability.

Particularly fine-pored and closed-pored foams are obtained when, in parallel with the reactive resin according to the invention, polyphosphates and melamine in a ratio of between 3 to 1 and 1 to 1, for example 2 to 1, are surprisingly mixed in.

The initiator generally consists of one or more peroxides and/or azo initiators, preferably a peroxide. It may be used as an initiator system together with an accelerator, generally one or more tertiary amines, especially an aromatic tertiary amine. A particularly suitable example of such an initiator is dibenzoyl peroxide, which can be used for example also in the form of a safe, preformulated paste in which the auxiliaries contained in said paste, for example paraffins, do not in the appropriate concentrations interfere with the formulation.

Examples of accelerators include in particular N,N-dialkyl para-toluidines, for example N,N-bis(2-hydroxypropyl)-para-toluidine or N,N-dimethyl-para-toluidine or N,N-dimethylaniline. The formulation of the actual coating composition can take place as follows: the reactive resin is formulated with the blowing agents, additives, optional fillers and further optional fillers. Such intermediate formulations are then split into two fractions that are for example equal in size. One of these fractions is then additionally mixed with the accelerator. These two fractions are then stable to storage for a long period.

Before the actual application, the accelerator-free fraction is then mixed with the initiator or initiator mixture. After a longer period of storage or transport, it may first be necessary to stir both fractions again, since fillers, for example, may have settled. After stirmng in or otherwise mixing in the initiator, the two fractions of the 2C system are then mixed together. This starts the polymerization of the monomeric constituents of the reactive resin, this being the start of the so-called pot life within which the application to the substrate, that is to say for example to a steel girder, must take place. With modern application devices, the mixing of the two fractions of the 2C system can also take place in a mixing chamber of an application nozzle immediately before pressure-indicated spraying.

The pot lives derive from a combination of nature and concentration of the initiator and accelerator, the monomer mixture and external influencing factors, for example the ambient temperature. These factors can be easily estimated and adjusted by those skilled in the art. Working with pot lives of several minutes to several hours is generally customary; these can also exceed the 20-hour mark.

The present invention also provides a process for the intumescent coating of a metal surface. In this process, the above-described formulation for the 2C intumescent coating is prepared, applied to the metal surface within 1 to 20 minutes and cured thereon at a temperature of between −5 and 30° C., preferably between 0 and 30° C., within a period of 60 minutes. The preferred layer thickness of the unfoamed coating is 1 to 20 mm, more preferably 1.5 to 7.5 mm. This would be formulated such that, in the event of a fire, the coating would preferably result in a foam having a specific layer thickness of 5 to 100 mm per mm layer thickness, preferably 15 to 50 mm per mm layer thickness.

### EXAMPLES

### Example 1

### Monomer Feed Process'

The first monomer mixture for the polymer component, consisting of 23% by weight of MMA, 33% by weight of ethylhexyl methacrylate, 36% by weight of n-butyl methacrylate and 8% by weight of beta-CEA (2-carboxyethyl acrylate), is mixed at room temperature with 1% by weight of 2-ethylhexyl thioglycolate and 0.6% by weight of di-(4-tert-butylcyclohexyl) peroxydicarbonate or 2,2′-azobis(isobutyronitrile) for the target molecular weight of approx. 60 000 g/mol. A 25% proportion of the first monomer mixture is heated to 74° C. as a prebatch with stirring, the heating is switched off and, at 86° C., the mixture is polymerized autothermally at approx. 90 to 149° C. by continuous addition of the remaining 75% proportion of the first monomer mixture. After an addition time of approx. 30 to 60 minutes, the process is complete. After the further reaction time of approx 45 minutes, the batch is diluted by addition of the second monomer mixture, consisting of 79% by weight of methyl methacrylate, 20% by weight of ethylhexyl acrylate and 1% by weight of methacrylic acid, in a ratio of 30% by weight of polymer proportion and 70% by weight of monomer mixture, cooled to 30° C. and stabilized with 15 ppm (15 mg/kg) of 2,6-di-tert-butyl-4-methylphenol (Topanol O), and then formulated with 1.2% by weight of waxes (dropping point approx. 60° C.) and 1.9% by weight of N,N-bis-(2-hydroxypropyl)-para-toluidine.

The viscosity is determined via the flow time, 30 s DIN Cup 4, corresponding to 30-150 mPa*s at 20° C. The target polymer content is approx. 30-35%. The polymer formed has a glass transition temperature of approx. −5° C. and is not crosslinked.

### Example 2

### Initiator Feed Process

The first monomer mixture for the polymer component, consisting of 23% by weight of MMA, 33% by weight of ethylhexyl methacrylate, 36% by weight of n-butyl methacrylate and 8% by weight of beta-CEA (2-carboxyethyl acrylate), is mixed at room temperature with approx. 2% by weight of 2-ethylhexyl thioglycolate. The first monomer mixture is heated to 74° C. with stirring, the heating is switched off and, at 86° C., the mixture is polymerized autothermally at approx. 90 to 120° C. by continuous addition of the 0.6% by weight of di-(4-tert-butylcyclohexyl) peroxydicarbonate or 2,2′-azobis(isobutyronitrile) as a 10% by weight strength solution in n-butyl acetate for the target molecular weight of approx. 60 000 g/mol. After an addition time of approx. 60 to 120 minutes, the process is complete. After the further reaction time of approx. 45 minutes, the batch is diluted by addition of the second monomer mixture, consisting of 79% by weight of methyl methacrylate, 20% by weight of ethylhexyl acrylate and 1% by weight of methacrylic acid, in a ratio of 30% by weight of polymer proportion and 70% by weight of monomer mixture, cooled to 30° C. and stabilized with 15 ppm (15 mg/kg) of 2,6-di-tert-butyl-4-methylphenol (Topanol O), and then formulated with 1.2% by weight of waxes (dropping point approx. 60° C.) and 1.9% by weight of N,N-bis-(2-hydroxypropyl)-para-toluidine.

The viscosity is determined via the flow time, 30 s DIN Cup 4, corresponding to 30-150 mPa*s at ° C. The target polymer content is approx. 30-35%. The polymer formed has a glass transition temperature of approx. −5° C. and is not crosslinked.

### Comparative Example 1

Degalan® 1710 and Degalan®1720 are mixed in equal parts.

### Curing of the Resin Systems:

2% by weight of benzoyl peroxide based on resin mixture

### Comparative Example 1

Pot life: 18 min

Tmax: 85° C. after 34 min, target: 70-130° C. after 15-40 min

Glass transition temperature: 64° C.

### Example 1

Pot life: 18 min

Tmax: 90° C. after 42 min; target: 70-130° C. after 15-40 min

Glass transition temperature: approx −5° C. and approx. 74° C.

The lower glass transition temperature here relates to the polymer from the partial polymerization of the first monomer mixture, whereas the higher glass transition temperature relates to the polymer formed during final curing of the coating.

### Formulation of a Fire-Resistant Coating

### Use Example:

33.8% by weight of the reactive resin according to example 1 and comparative example 1 is in each case preformulated with 30.0% by weight of ammonium phosphate, 9.2% by weight of pentaerythritol, 15.0% by weight of melamine, 10.0% by weight of titanium dioxide and 1% by weight each of kaolin and wetting agent. These formulations are each divided into two equal-sized fractions, with 0.5% by weight of benzoyl peroxide, based on the total formulation, added to one fraction. These two fractions are then mixed together and a smaller portion withdrawn. The larger portion is used to coat a steel plate in a layer thickness of 2000 μm, while the smaller sample is used to measure the pot life and the maximum temperature after mixing.

### Foaming Experiment

### Experiments in the High Therm VMK 39 Muffle Furnace

Initiated resin filler system is applied with a 3000 μm doctor blade to a degreased, 0.8 mm thick steel plate. After being left to cure for 24 hours, the coated plate is placed in the cold muffle furnace and heated to the desired temperature. On reaching the temperature, the temperature is held for one hour, after which the oven is allowed to cool.

Assessment of the intumescent coating after thermal foaming, specific foam height, foam quality and adhesion to the steel plate

| | | | Coating height | Specific foam | | |
|---|---|---|---|---|---|---|
| | | | after complete | height mm/ | | Overhead |
| | | T/ | polymeriza- | mm coating | Foam quality in | adhesion after |
| Example | Designation | ° C. | tion/mm | height | cross section | thermal foaming |
| CE1 | Comparative | 500 | 2.7 | 16.7 | Large to | No adhesion to |
| | example | | | | medium-sized | the steel plate |
| | | | | | pores, open- | |
| | | | | | pored | |
| CE2 | Comparative | 1000 | 2.8 | 18.2 | Large to | No adhesion to |
| | example | | | | medium-sized | the steel plate |
| | | | | | pores, open- | |
| | | | | | pored | |
| 1 | Inventive | 500 | 2.4 | 20.6 | Fine-pored, | Adhesion to the |
| | example | | | | closed-pored | steel plate |
| 2 | Inventive | 1000 | 2.7 | 19.8 | Fine-pored, | Adhesion to the |
| | example | | | | closed-pored | steel plate |

The results for examples 1 and 2 demonstrate a higher specific foam height and these are therefore able to develop a better fire-insulating effect.

1. A process for producing a reactive resin for intumescent coatings, the process comprising:
polymerizing a first monomer mixture comprising at least one acid-functionalized monomer to a degree of polymerization of 70% by weight to 95% by weight, after which the polymerization is terminated,
wherein a polymer thereby formed has a glass transition temperature, calculated according to the Fox equation, of less than 23° C., and
wherein, after termination of the polymerization, the first monomer mixture containing 70% to 95% by weight of polymer is diluted with a second monomer mixture that differs from the first monomer mixture.

2. The process according to claim 1, wherein the first monomer mixture consists to an extent of at least 90% by weight of acrylates and/or methacrylates, and in that the at least one acid-functionalized monomer in the first monomer mixture is acrylic acid, methacrylic acid, itaconic acid or 2-carboxyethyl acrylate.

3. The process according to claim 2, wherein the polymer formed contains between 1% and 10% by weight of repeat units of the at least one acid-functionalized monomer, based on a total weight of the polymer formed.

4. The process according to claim 1, wherein the second monomer mixture contains 50% to 90% by weight of methyl methacrylate, based on a total weight of the second monomer mixture.

5. The process according to claim 1, wherein the first monomer mixture consists of the at least one acid-functionalized monomer and at least one further monomer selected from the group consisting of methyl methacrylate, n-butyl (meth)acrylate, isobutyl (meth)acrylate, ethyl (meth)acrylate, propyl (meth)acrylate, ethylhexyl (meth)acrylate, and styrene.

6. The process according to claim 1, wherein the polymer formed has a weight-average molecular weight Mw of between 10 000 and 200 000 g/mol and a glass transition temperature of between −20° C. and 20° C.

7. The process according to claim 1, wherein the polymerization is carried out discontinuously in a batchwise process or continuously in a continuously operated stirred-tank reactor with a connecting flow tube, with the reaction terminated by lowering the temperature, adding an inhibitor and/or through consumption of an initiator.

8. The process according to claim 1, wherein the degree of polymerization on termination of the polymerization is between 85% and 95% by weight.

9. The process according to claim 1, wherein the second monomer mixture contains to an extent of at least 90% by weight of acrylates and/or methacrylates, up to 5% by weight of acid-functionalized monomers, and optionally styrene, in each case based on a total weight of the second monomer mixture.

10. The process according to claim 1, wherein the second monomer mixture is selected such that, when fully polymerized, the second monomer mixture would lead to a polymer having a glass transition temperature according to the Fox equation of between 50° C. and 120° C.

11. A formulation for a 2C intumescent coating, wherein, after mixing a 2C system, the formulation contains
20% to 40% by weight of the reactive resin producible according to claim 1,
35% to 60% by weight of a blowing agent,
0.1% to 2.5% by weight of a peroxide and/or azo initiator,
optionally up to 2% by weight of an accelerator,
optionally 4.9% to 15% by weight of additives, and
5% to 30% by weight of fillers, in each case based on a total weight of the 2C system.

12. A formulation for a 2C intumescent coating, wherein, after mixing a 2C system of the reactive resin producible according to claim 1, the formulation has a blowing agent ratio of polyphosphate to melamine of between 1 to 1 and 3 to 1.

13. The formulation according to claim 11, wherein the formulation additionally comprises pigments.

14. A process for the intumescent coating of a metal surface, the process comprising:
applying the formulation prepared according to claim 11 to the metal surface within 1 to 20 minutes of a beginning of mixing and curing thereon at a temperature of between −5 and 30° C. within a period of 60 minutes after mixing.

15. The process according to claim 1, wherein the first monomer mixture consists to an extent of at least 90% by weight of acrylates and/or methacrylates, and in that the at least one acid-functionalized monomer in the first monomer mixture is methacrylic acid or 2-carboxyethyl acrylate.

16. The process according to claim 2, wherein the polymer formed contains between 2.5% and 5% by weight, of repeat units of the at least one acid-functionalized monomer, based on a total weight of the polymer formed.

17. The process according to claim 1, wherein the polymer formed has a weight-average molecular weight Mw of between 10 000 and 200 000 g/mol and a glass transition temperature of between −10 and 15° C.

18. The process according to claim 1, wherein the second monomer mixture contains to an extent of at least 90% by weight of methyl methacrylate, n-butyl (meth)acrylate, isobutyl (meth)acrylate, ethyl (meth)acrylate, propyl (meth)acrylate and/or ethylhexyl (meth)acrylate, up to 5% by weight of acrylic acid, methacrylic acid, itaconic acid and/or 2-carboxyethyl acrylate, and optionally styrene, in each case based on a total weight of the second monomer mixture.

19. The process according to claim 1, wherein the second monomer mixture is selected such that, when fully polymerized, the second monomer mixture would lead to a polymer having a glass transition temperature according to the Fox equation of between 60 and 90° C.
